(19) United States
(12) Patent Application Publication
(10) Pub. No.: US 2022/0379878 A1
(43) Pub. Date: Dec. 1, 2022

(54) Parking Assist System and Parking Assist Method

(71) Applicant: Faurecia Clarion Electronics Co., Ltd., Saitama (JP)

(72) Inventor: Makoto ISHINODA, Saitama (JP)

(73) Assignee: Faurecia Clarion Electronics Co., Ltd., Saitama (JP)

(21) Appl. No.: 17/750,779

(22) Filed: May 23, 2022

(30) Foreign Application Priority Data
May 28, 2021 (JP) 2021-090533

(51) Int. Cl. B60W 30/06; B60W 40/12

(52) U.S. Cl. CPC B60W 30/06; B60W 40/12; B60W 2554/80; B60W 2520/06; B60W 2720/24

(57) ABSTRACT

A parking assist system comprises a route generating unit for generating a generating position for generating a parking route for parking a vehicle in a determined parking space and for generating a travel route for the vehicle to travel to the generating position; and a control information generating unit for generating control information for the vehicle to travel along the travel route by controlling a driving system 80 for causing the vehicle to travel, and for outputting the generated control information to a vehicle controlling unit for controlling the driving system, wherein: the route generating unit determines a generating position such that at least a portion of the back end of the vehicle will be positioned within a parking space, and, after the vehicle has arrived at the generating position, generates, at the generating position, a parking route for the vehicle to park in the parking space.

### CROSS-REFERENCE TO RELATED APPLICATIONS

The present application claims priority under 35 U.S.C. § 119 to Japanese Patent Application No. 2021-090533 filed on May 28, 2021. The content of the application is incorporated herein by reference in its entirety.

### BACKGROUND OF THE INVENTION

### Field of the Invention

The present invention relates to a parking assist system and parking assist method.

### Description of the Related Art

A parking assist system is known that detects the state of the surroundings of a vehicle, generates a parking route based on the detected state of the surroundings, and causes the vehicle to travel along the generated parking route to cause parking in a target parking position.

For example, the parking assist system described in Patent Document 1 comprises: parking route calculating means for calculating a parking route for a vehicle to back to a target parking position; assisting means for assisting backing of the vehicle along the parking route calculated by the parking route calculating means; obstacle location correcting means for correcting a location of an obstacle that was detected when traveling forward, based on a comparison of a location detected by rearward distance measuring means when backing and a location detected when traveling forward, in respect to an obstacle that is adjacent to a parking space; and target parking position correcting means for correcting a target parking position depending on an amount of correction corrected by the obstacle location correcting means, where the parking route calculating means recalculate the parking route to be traveled by the vehicle to the target parking position based on the corrected target parking position and the current position of the vehicle.

### PRIOR ART DOCUMENTS

### Patent Documents

[Patent Document 1] Japanese Unexamined Patent Application Publication 2014-54912

### SUMMARY OF THE INVENTION

### Problem Solved by the Present Invention

However, when the detection accuracy of an onboard sensor is low, the accuracy of the inputted surroundings information that indicates the state of the surroundings of the vehicle will be low, making it impossible to park the vehicle in the ideal position within the parking space. When a vehicle is parked in a parking position while correcting the positions of the obstacles as in Patent Document 1, the parking process will be time-consuming.

### SUMMARY OF THE INVENTION

The present invention was created in contemplation of the situation set forth above, and the object thereof is to provide a parking assist system and parking assist method able to park a vehicle in an appropriate position within a parking space and shorten the time required for parking.

### Means for Solving the Problem

The parking assist system according to the present invention, by which to achieve the object set forth above, comprises: an input/output interface configured to connect to onboard sensors that are mounted at a plurality of locations including the back end of a vehicle; a parking position determining unit configured to determine a parking space for parking the vehicle based on inputted surroundings information, when surroundings information that indicates the state of the surroundings of the vehicle is inputted from the onboard sensors through the input/output interface; a route generating unit configured to determine a generating position that is a position for generating a parking route for parking the vehicle in the parking space that has been determined, and generate a travel route for travel of the vehicle to the generating position; and a control information generating unit configured to generate control information for controlling a driving system for traveling the vehicle along the travel route and output the control information through the input/output interface to a control device for controlling driving of the driving system, wherein: the route generating unit determines the generating position so as to position a portion of the back end of the vehicle within the parking space, and, generates a parking route from the generating position to the parking space when the vehicle has arrived at the generating position.

### Effects of the Invention

The present invention enables parking of a vehicle in an appropriate position within a parking space, and enables the time required for parking to be shortened, even if the onboard sensor detection accuracy is poor.

### BRIEF DESCRIPTION OF THE DRAWINGS

FIG. 1 is a block diagram showing a structure of an onboard system.

FIG. 2 is a diagram showing an example of a travel route.

FIG. 3 is a diagram showing the state of parking at a position that is not centered in a parking space.

FIG. 4 is a diagram showing the vehicle positioned at a starting position and an intermediate position.

FIG. 5 is a diagram showing a state wherein a vehicle turn angle exceeds an upper limit value.

FIG. 6 is a diagram showing a generating position.

FIG. 7 is a diagram showing a generating position.

FIG. 8 is a diagram showing an example of a route that the route generating unit does not generate as a backward turning route

FIG. 9 is a diagram showing an example of a route that the route generating unit does not generate as a backward turning route.

FIG. 10 is a diagram showing an example of a route that the route generating unit does not generate as a backward turning route.

FIG. 11 is a diagram showing a parking route generated after traveling to the generating position.

FIG. 12 is a flowchart showing the operation of the parking assist system.

FIG. 13 is a flowchart showing the operation of the parking assist system.

### DETAILED DESCRIPTION OF THE INVENTION

An embodiment will be explained below in reference to the appended drawings.

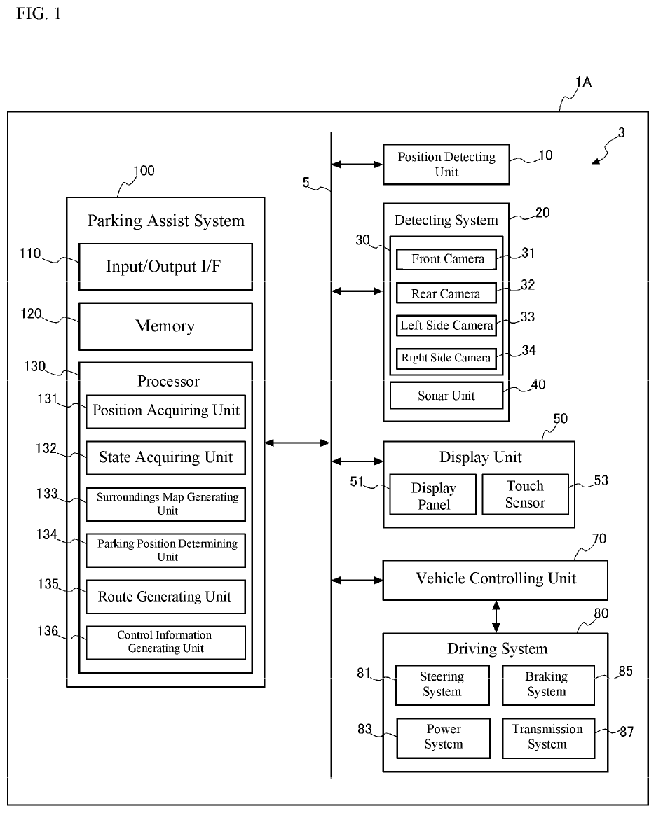

FIG. 1 is a block diagram showing a structure of an onboard system 3. In the below, the vehicle on which the onboard system 3 is equipped will be termed “the vehicle 1A,” and a vehicle other than the vehicle 1A will be termed an “other vehicle 1B.”

The onboard system 3 comprises a position detecting unit 10, a detecting system 20, a display unit 50, a vehicle controlling unit 70, a driving system 80, and a parking assist system 100.

The position detecting unit 10 detects the position of the vehicle 1A. The position detecting unit 10 comprises a GNSS (Global Navigation Satellite System) receiver and a processor (neither of which are shown). The GNSS receiver receives signals transmitted from satellites. The processor calculates the latitude and longitude, which are location information for the vehicle 1A, based on the signals received by the GNSS receiver, and calculates the bearing of the vehicle 1A based on differences in calculated location information. The position detecting unit 10 outputs, to the parking assist system 100, the location information and orientation information calculated for the vehicle 1A.

The detecting system 20 comprises a plurality of onboard sensors. The detecting system 20 according to the present embodiment comprises, as onboard sensors, an imaging unit 30 that has a plurality of cameras and sonar units 40.

While in the present embodiment a case wherein the detecting system 20 comprises cameras and sonar, the onboard sensor of the detecting system 20 is not limited to cameras and sonar. For example, radar or LIDAR (Laser Imaging Detection and Ranging), able to measure distance to objects using radio signals, light, or the like, may be provided in the detecting system 20. The detecting system 20 outputs, to the parking assist system 100, the images captured by the imaging unit 30 and the sensor data of the sonar unit 40, as surroundings information that indicates the state of the surroundings.

The imaging unit 30 comprises a front camera 31 for imaging forward of the vehicle 1A, a rear camera 32 for imaging rearward of the vehicle 1A, a left side camera 33 for imaging toward the left side of the vehicle 1A, and a right side camera 34 for imaging toward the right side of the vehicle 1A. These cameras are each equipped with image sensors such as, for example, CCDs (Charge-Coupled Devices) or CMOS (Complementary Metal-Oxide-Semiconductor) sensors, or the like, and with data processing circuits for generating images from the states of light reception of the image sensors. In the imaging units 30, the viewing angles are adjusted so as to enable imaging of a range of 360°, centered on the vehicle 1A, through the four cameras. The front camera 31, the rear camera 32, the left side camera 33, and the right side camera 34 each carries out imaging of the respective imaging range at a prescribed frame rate, to generate captured images. The front camera 31, the rear camera 32, the left side camera 33, and the right side camera 34 output the generated captured images to the parking assist system 100.

The sonar units 40 are mounted at a plurality of locations on the vehicle 1A, such as the front end, back end, left side, right side, and the like, and use ultrasound to detect objects that are present in the surroundings of the vehicle 1A. Specifically, the sonar unit 40 detects the location of an object and the distance to the object.

The display unit 50 comprises a display panel 51 and a touch sensor 53. A liquid crystal display or an organic EL display, for example, is used in the display panel 51. The touch sensor 53 uses a sensor of a commonly known method, such as a resistance film method, an electrostatic capacitance method, or the like. The touch sensor 53 detects a touch operation that is performed on the display, 51, to generate coordinate information indicating the location of the detected touch operation. The touch sensor 53 outputs, to the parking assist system 100, an operating signal that includes the generated coordinate information.

The vehicle controlling unit 70 is a computer device such as, for example, an ECU (Electronic Control Unit), and is a controlling device for controlling the driving system 80 that is mounted in the vehicle 1A. The driving system 80 includes a steering system 81, a power system 83, a braking system 85, and a transmission system 87. The vehicle controlling unit 70 is connected to the parking assist system 100 through a communication bus 5 that follows a standard such as Ethernet®, CAN (Controller Area Network), LIN (Local Interconnect Network), or the like. The vehicle controlling unit 70 controls the steering system 81, the power system 83, the braking system 85, and the transmission system 87 in accordance with control information inputted from the parking assist system 100.

The steering system 81 is a system that includes an actuator for steering the steering wheel of the vehicle 1A.

The power system 83 is a system that includes an actuator for adjusting the driving force on the drive wheels of the vehicle 1A. This actuator corresponds to a “throttle actuator,” if the power source of the vehicle 1A is an engine, or corresponds to the “motor” if the power source is a motor.

The braking system 85 controls the braking system that is provided in the vehicle 1A, based on information from the parking assist system 100, and includes actuators for controlling the braking forces that are applied to the wheels of the vehicle 1A. The transmission system 87 is a system that includes a transmission and an actuator. The transmission system 87 drives the actuator to control the shift position of the transmission, to shift the reduction ratio of the transmission and to Swift the vehicle 1A between forward and backward.

Moreover, the vehicle controlling unit 70 outputs a completion notification and a stopped notification to the parking assist system 100. When the control of the driving system 80, based on the control information, has been completed and the vehicle 1A arrives at the target position set in the control information, the vehicle controlling unit 70 outputs a completion notification to the parking assist system 100.

Additionally, when, during control of the driving system 80, an obstacle, or the like, is detected and motion of the vehicle 1A is stopped, or when motion of the vehicle 1A is stopped through an operation by the driver, the vehicle controlling unit 70 outputs a stopped notification to the parking assist system 100.

The parking assist system 100 is a computer system comprising an input/output interface 110, a memory 120, and a processor 130. The parking assist system 100 may be structured comprising, along with these devices, a storage device such as an HDD (Hard Disk Drive), an SSD (Solid-State Drive), or the like. In the below, “interface” will be abbreviated “I/F.”

The input/output I/F 110 is connected to the communication bus 5 to carry out data communication with external systems connected to the communication bus 5. The external systems include the position detecting unit 10, the detecting system 20, the display unit 50, and the vehicle controlling unit 70.

The memory 120 is structured from a ROM (Read-Only Memory), a RAM (Random Access Memory), or the like. Moreover, the memory 120 may be structured from a non-volatile semiconductor memory such as a flash memory. The memory 120 stores a computer program to be executed by a processor 130, data that is to be processed when the processor 130 executes the computer program, and/or data that is the result of processing. Moreover, the memory 120 stores the captured images that are captured by the imaging unit 30, the sensor data outputted by the sonar units 40, and the like.

The processor 130 is structured from a CPU (Central Processing Unit), an MPU (Microprocessor Unit), or the like.

The parking assist system 100 comprises, as functional structures, a position acquiring unit 131, a state acquiring unit 132, a surroundings map generating unit 133, a parking position determining unit 134, a route generating unit 135, and a control information generating unit 136. These functional structures are functions achieved through carrying out calculations by the processor 130 executing a computer program.

The position information and orientation information for the vehicle 1A, calculated by the position detecting unit 10, are inputted into the position acquiring unit 131. The position acquiring unit 131 uses a well-known dead reckoning technique to correct the position information and/or orientation information that has been inputted by the position detecting unit 10. The position acquiring unit 131 outputs the corrected position information and orientation information to the surroundings map generating unit 133 and route generating unit 135.

The state acquiring unit 132 causes execution of imaging by the imaging unit 30, to acquire, as surroundings information, the captured images generated by the imaging unit 30. The state acquiring unit 132 stores temporarily, in the memory 120, the captured images that have been acquired by the imaging unit 30.

Moreover, the state acquiring unit 132 causes the sonar units 40 to execute sensing, to acquire, as surroundings information, the sensor data that are the sensing results by the sonar units 40. The state acquiring unit 132 stores temporarily, in the memory 120, the sensor data that have been acquired from the sonar units 40.

The surroundings map generating unit 133 generates a surroundings map, showing the state of the surroundings of the vehicle 1A, based on the position information and orientation information, inputted from the position acquiring unit 131, and the captured images and sensor data stored in the memory 120. The surroundings map records, for example, positions of objects that are located around the vehicle 1A, the distances to those objects, the positions of parking spaces, such as white lines, or the like, that are painted on the surface of the parking lot, and the like. Other vehicles 1B, parked in parking spaces, structures, such as columns, of the parking lot, and the like, for example, are included in the objects that are recorded in the surroundings map. Because the lines of parking spaces are painted on the road surface with prescribed widths, regions corresponding to the widths of the white lines are detected as periodic distinctive features.

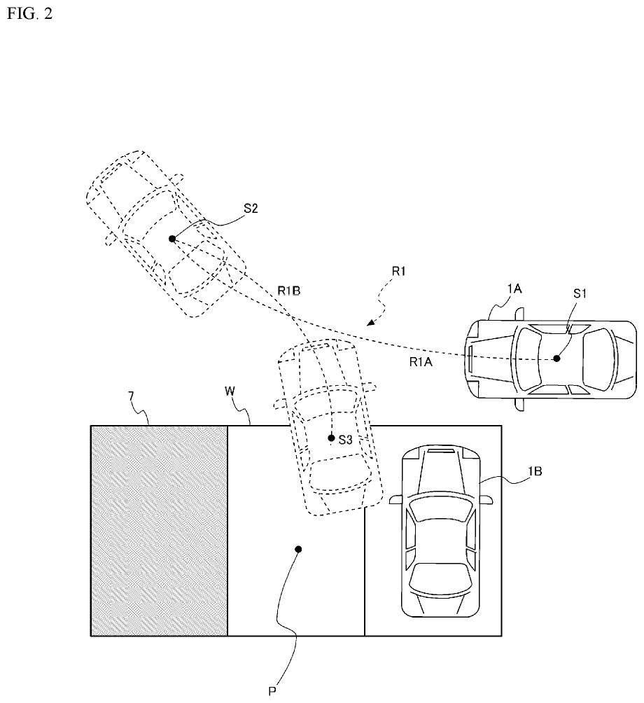

The parking position determining unit 134 references the surroundings map, generated by the surroundings map generating unit 133, to determine a parking space W (referencing FIG. 2) for parking the vehicle 1A. For example, the parking position determining unit 134 selects a parking space W that is no greater than a preset distance, wherein a distance that has been set in advance, from the vehicle 1A, from those parking spaces that are recorded in the surroundings map without an obstacle having been detected. The parking position determining unit 134 determines a parking position P by setting a location and an angle for parking the vehicle 1A within the selected parking space W.

The route generating unit 135 determines a generating position S3 (referencing FIG. 2), and generates a travel route R1 by which the vehicle 1A will travel to the generating position S3 that has been determined. The route generating unit 135 references the surroundings map to generate the travel route R1 through publicly known means.

The generating position S3 is the position wherein the route generating unit 135 will generate a parking route R2. The parking route R2 is a route by which the position of the vehicle 1A will travel from the generating position S3 to the parking position P. The parking assist system 100 determines, as the generating position S3, a position other than the position at which the operation for starting the parking assist was received through the touch panel, or the like, and generates the parking route R2 at the generating position S3 that was determined. Moreover, the generating position S3 is generated so that at least a portion of the back end of the vehicle 1A will be positioned within the parking space W. The process for determining the generating position S3 and the travel route R1 will be explained below in reference to FIG. 2 through FIG. 11. Note that the route wherein the end of the route is the parking position P is termed the “parking route, while a route wherein the end of the route is other than the parking position P is termed a “travel route.”

FIG. 2 is a diagram showing an example of a travel route R1 and a parking space. FIG. 2 shows that another vehicle 1B is parked in the adjacent parking space on the right (from the perspective of the drawing) of the parking position P, and that a parking lot structure 7, such as a column, or the like, is located next to the parking position P on the left (from the perspective of the drawing). A forward turning route R1A, an intermediate position S2, and a backward turning route R1B are included in the travel route R1, as shown in FIG. 2.

The forward turning route R1A is a route wherein the vehicle 1A moves forward while turning, where a route wherein the vehicle 1A travels straight forward may be included in a portion of the route.

The backward turning route R1B is a route wherein the vehicle 1A moves in backward while turning, where a route wherein the vehicle 1A travels straight backward may be included in a portion of the route.

The intermediate position S2 is a position wherein the direction of travel of the vehicle 1A switches from forward to backward, where the travel of the vehicle 1A briefly stops, a shift operation is carried out, and the direction of travel of the vehicle 1A changes from moving forward to moving in backward.

Moreover, the position S1 depicted in FIG. 2 is the position wherein an operation for starting the parking assist is received through the touch panel, where the parking assist system 100 generates the travel route R1. In the below, the position S1 will be termed the “starting position S1.”

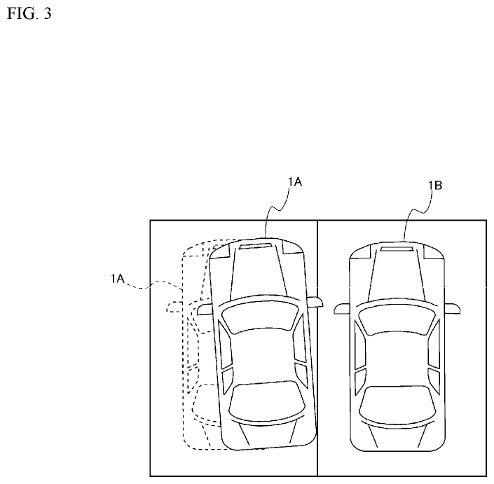

FIG. 3 is a diagram showing the state wherein the vehicle 1A has parked at a position that is not centered in the parking space W.

Here an explanation will be given regarding why the parking assist system 100 generates the parking route R2 at the generating position S3 rather than the starting position S1.

If the detection accuracy of the sonar units 40 that are mounted in the vehicle 1A is low, the detection accuracy of the parking space and of obstacles will be low, which may cause the vehicle 1A to park in a position that is not centered in the parking space W when parked at the parking position P. The vehicle 1A indicated with dotted lines in FIG. 3 shows a case wherein the vehicle 1A is parked at a suitable position in the parking space W, and the vehicle 1A indicated by solid lines in FIG. 3 shows a case wherein the vehicle 1A is parked shifted toward the right side (from the perspective of the drawing) of the parking space W, and also askew with respect to the parking space W. When the vehicle 1A is parked at a position that is not centered, as shown in FIG. 3, it becomes impossible to correct the parking position, given the limitations on movement of the vehicle 1A, and the vehicle 1A will be too close to the other vehicle 1B that is parked to the right thereof, which may cause the door of the vehicle 1A to strike the other vehicle 1B when opened and closed.

Given the detection accuracy of the sonar units 40, the parking assist system 100 determines the travel route R1 and the generating position S3 so as to position at least a portion of the back end of the vehicle 1A within the parking space W, as illustrated in FIG. 2. The sonar units 40 can have higher detection accuracy when closer to the object being measured.

Moreover, the detection accuracies of the sonar units 40 are set so that the detection accuracy at the back end of the vehicle 1A will be higher than at the front in the sides of the vehicle 1A. This design is from the perspective of improving safety toward the rear of the vehicle 1A, given that the rear of the vehicle 1A has many angles that cannot be seen by the driver. Because of this, the parking assist system 100 directs the back end of the vehicle 1A toward the parking position P, and sets the travel route R1 and the generating position S3 so that at least a portion of the back end of the vehicle 1A will be within the parking space W, preventing a reduction in accuracy of detection of obstacles, and the like, that would be caused by the detection accuracy of the sonar units 40.

When the vehicle 1A travels to the generating position S3, the route generating unit 135 generates a parking route R2 by which the vehicle 1A will travel from the generating position S3 to the parking position P. After the vehicle 1A has arrived at the generating position S3, the route generating unit 135 generates the parking route R2 based on the sensor data and captured images acquired by the state acquiring unit 132 at the generating position S3 and the surroundings map that has been generated by the surroundings map generating unit 133 based on this information.

A method for determining the generating position S3 will be explained next.

The route generating unit 135 first sets a forward turning route R1A. The route generating unit 135 sets the forward turning route R1A and an intermediate position S2 through varying two parameters: travel distance t1 and turning angle θ1. The travel distance t1 is a travel distance in, for example, the width direction of the vehicle 1A.

The turning angle θ1 is the angle of rotation toward the right, with respect to the length direction of the vehicle as the reference, when, for example, the vehicle 1A is located at the starting position S1.

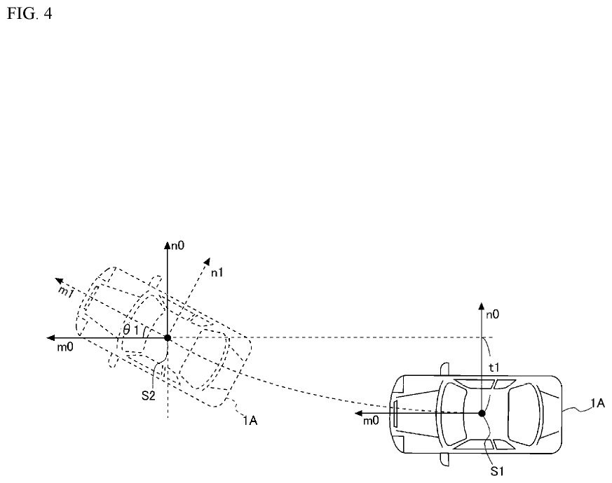

FIG. 4 is a diagram showing the vehicle 1A at the starting position S1 and the intermediate position S2.

FIG. 4, the vehicle-length direction (the reference direction) when the vehicle 1A is located at the starting position S1 is indicated as m0, and the vehicle-width direction is indicated as n0. Moreover, the vehicle-length direction of the vehicle 1A when the vehicle 1A has moved to the intermediate position S2 is indicated as m1, and the vehicle-width direction is indicated as nl. The travel distance t1 is the distance, in the vehicle-width direction n0, between the starting position S1 and the intermediate position S2, as indicated in FIG. 4. Moreover, the turning angle θ1 is the angle formed between the vehicle-length direction m0 at the starting position S1 and the vehicle-length direction m1 at the intermediate position S2.

An upper limit value is set for the travel distance t1. The upper limit value for the travel distance t1 may be a value that has been set in advance, or may be determined based on a route width calculated using captured images for sonar data by the sonar units 40 for the route width of the route for positioning the vehicle 1A. That is, when parking spaces are provided on the side opposite from the parking position P, with the route therebetween, an upper limit value is set for the travel distance t1 so as to prevent a collision with another vehicle 1B that is parked on the opposite side.

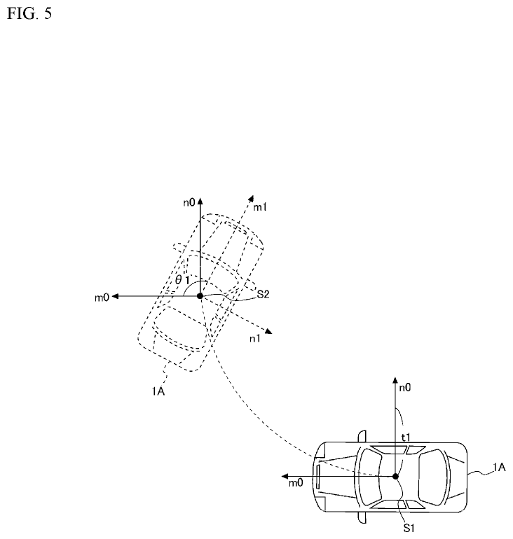

An upper limit value is set for the turn angle θ1 as well. FIG. 5 is a diagram showing a state wherein the turning angle θ1 of the vehicle 1A exceeds the upper limit value.

The route generating unit 135 evaluates that the turn angle θ1 is greater than the upper limit value if, for example, the turn angle θ1 is greater than the angle between the vehicle-length direction m0 at the starting position S1 and the vehicle-width direction n0.

Upon determination of the forward turning route R1A and the intermediate position S2, the route generating unit 135 next determines the backward turning route R1B for backing the vehicle 1A from the intermediate position S2 that has been determined, and determines the generating position S3. The route generating unit 135 determines the backward turning route R1B and the generating position S3 by varying the turn angle θ2 parameter. The range over which the value θ2 can be varied is set in advance for the turn angle θ2.

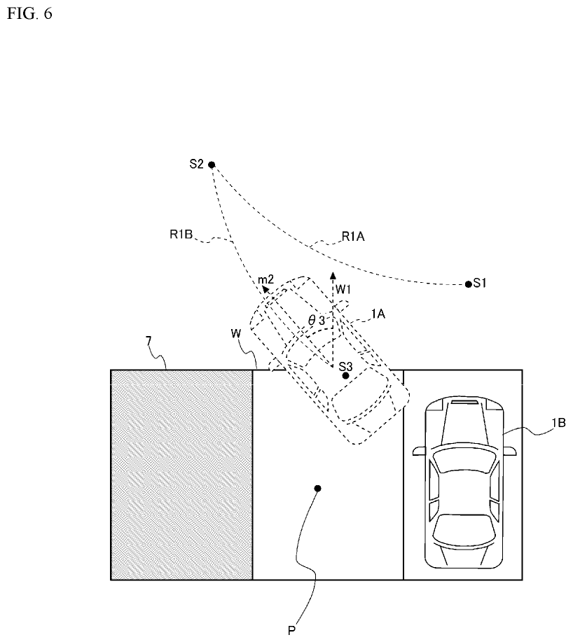

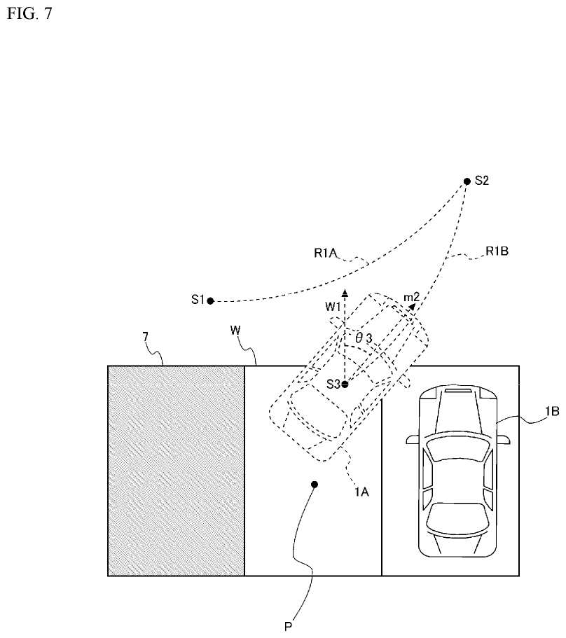

FIG. 6 and FIG. 7 are diagrams showing the generating position S3. In particular, FIG. 6 is a diagram showing the backward turning route R1B when the vehicle 1A has made a rearward right turn from the intermediate position S2. Moreover, FIG. 7 is a diagram showing the backward turning route R1B when the vehicle 1A has made a rearward left turn from the intermediate position S2.

The route generating unit 135 determines the backward route R1B and the generating position S3 while varying the turn angle θ2. The route generating unit 135 generates, as the backward turning route R1B, a route that will cause the back end of the vehicle 1A to approach an obstacle, to within a setting range that has been set in advance, as shown in FIG. 6. When a rearward right turning route is to be generated as the backward turning route R1B, as shown in FIG. 6, a backward turning route R1B is generated so that the distance between the side face of the other vehicle 1B, which is an obstacle that is located on the right side of the vehicle 1A, and the back end of the vehicle 1A will be within a setting range that has been set in advance.

Additionally, when the route generating unit 135 is to generate a rearward left turning route as the backward turning route R1B, as shown in FIG. 7, a backward turning route R1B is generated so that the distance between the structure 7, which is an obstacle that is located on the left side of the vehicle 1A, and the back end of the vehicle 1A will be within a setting range that has been set in advance. Generating, as the backward turning route R1B, a route such that the distance between the back end of the vehicle 1A and the side face of another vehicle 1B or a structure 7 will be within a setting range that has been set in advance, enables generating, as the backward turning route R1B, a route such that at least a portion of the back end of the vehicle 1A will be within the parking space W.

The route generating unit 135, upon generating a backward turning route R1B such that the distance between the back end of the vehicle 1A and an obstacle will be within a setting range that has been set in advance, calculates the angle θ3 that will be formed between the vehicle-length direction m2 of the vehicle 1A when the vehicle 1A is positioned at the end position of the backward turning route R1B and the lengthwise direction W1 of the parking space W.

If this is the first time that the angle θ3 is calculated, the route generating unit 135 stores the calculated angle θ3 in the memory 120. If there is a value for the angle θ3 stored in the memory 120, the route generating unit 135 compares the calculated angle θ3 to the angle θ3 that is stored in the memory 120. If the angle θ3 that was calculated is smaller than the angle θ3 that is stored in the memory 120, the route generating unit 135 stores the travel distance t1 and the turn angles θ1 and θ2, which are the parameters for this angle θ3, in the memory 120.

Generating, as the backward turning route R1B, a route that reduces this angle θ3 enables the backward turning route R1B to be set so that the vehicle 1A will be parallel to the vehicle-length direction of the parking space W, enabling easy generation of a parking route R2 by which the vehicle 1A, which has traveled to the generating position S3, will travel to the parking position P.

The route generating unit 135 varies the values for the travel distance t1 and the turn angles θ1 and θ2 that are the conditions, to find the values for the travel distance t1 and the turn angles θ1 in θ2 that minimize the angle θ3.

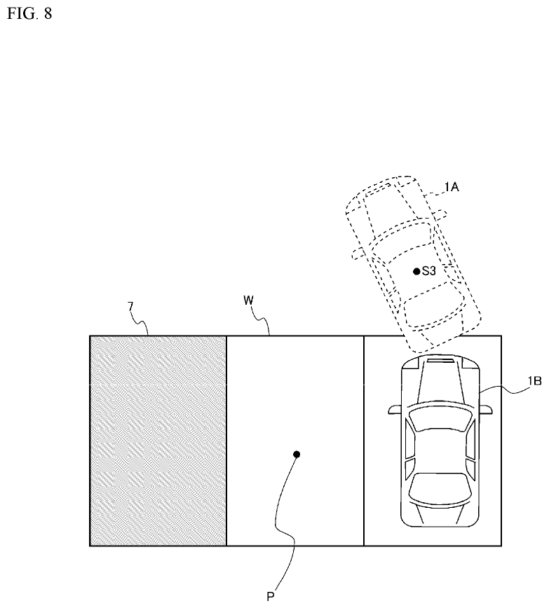

FIG. 8 through FIG. 10 are diagrams showing routes generated, as backward turning routes R1B, by the route generating unit 135.

FIG. 8 shows a case wherein the back end of the vehicle 1A collides with the front of another vehicle 1B that is parked to the right (in the perspective of the drawing) of the parking position P.

If, at the end of the backward turning route R1B, the back end of the vehicle 1A would collide with the front of the other vehicle 1B that is positioned to the right side of the parking position P, the route generating unit 135 excludes this route as a candidate for the backward turning route R1B. That is, the route generating unit 135 does not store, into the memory 120, the conditions that would generate this route (the travel distance t1 and turn angles θ1 and θ2).

Moreover, when the route generating unit 135 generates a rearward right turning route as the backward turning route R1B, any route wherein the distance from the side face of the obstacle that is adjacent to the parking space W on the right will not be within the setting range that has been set in advance is excluded from the candidates for the backward turning route R1B. Similarly, when the route generating unit 135 generates a rearward left turning route as the backward turning route R1B, any route wherein the distance from the side face of the obstacle that is adjacent to the parking space W on the left will not be within the setting range that has been set in advance is excluded from the candidates for the backward turning route R1B.

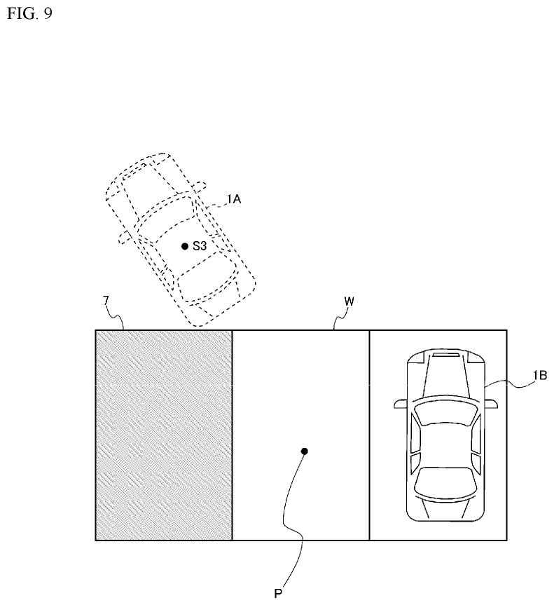

For example, as illustrated in FIG. 9, if a rearward right turning route is generated as the backward turning route R1B, a route that would contact or collide with a structure 7 that is an obstacle that is positioned on the left side of the parking space W would be excluded from the candidates for the backward turning route R1B.

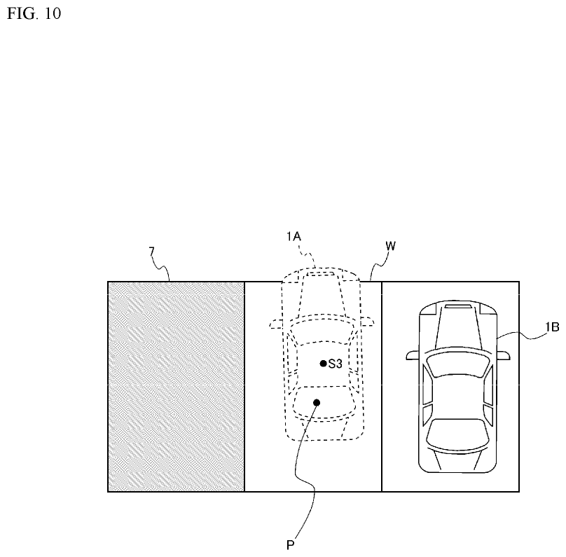

Moreover, as depicted in FIG. 10, if the distance between the vehicle 1A and the obstacle would be greater than the setting range that has been set in advance, despite the vehicle 1A traveling along the route, this route would be excluded from candidates for the backward turning route R1B. This is because it would be necessary to set another condition for stopping travel of the vehicle 1A if the distance between the vehicle 1A and the obstacle would not be within the setting range that is set in advance, and the settings for this condition cannot be determined uniformly.

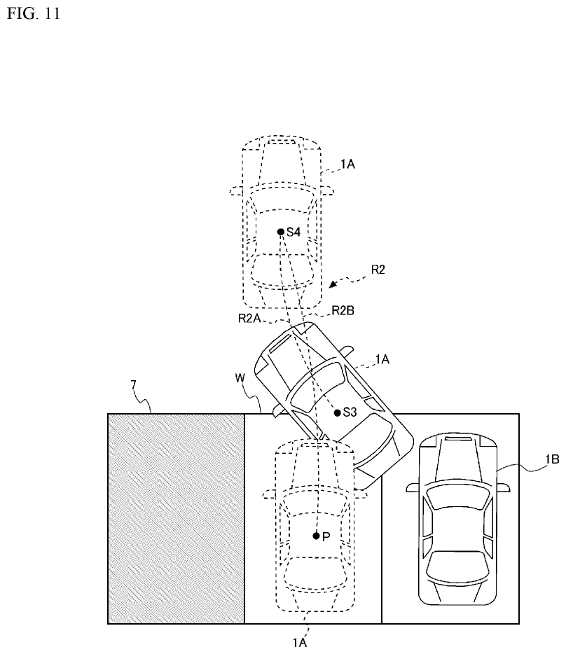

FIG. 11 is a diagram showing a parking route R2 generated by the route generating unit 135 after the vehicle 1A has traveled to the generating position S3.

When a completion notification has been inputted from the vehicle controlling unit 70, the route generating unit 135 evaluates whether or not the vehicle 1A has traveled to the generating position S3, based on the position information and orientation information inputted from the position detecting unit 10.

Upon evaluation that the vehicle 1A has arrived at the backward position, the route generating unit 135 generates a parking route R2 based on the surroundings map newly generated by the surroundings map generating unit 133. A forward turning route R2A, an intermediate position S4, and a backward turning route R2B are included in the parking route R2. The route generating unit 135 outputs, to the control information generating unit 136, the parking route R2 that has been generated.

The control information generating unit 136 generates control information corresponding to the parking route R2 that has been inputted from the parking assist system 100, and the control information generating unit 136 outputs the generated control information to the vehicle controlling unit 70. The parking of the vehicle 1A at the parking position P is completed thereby.

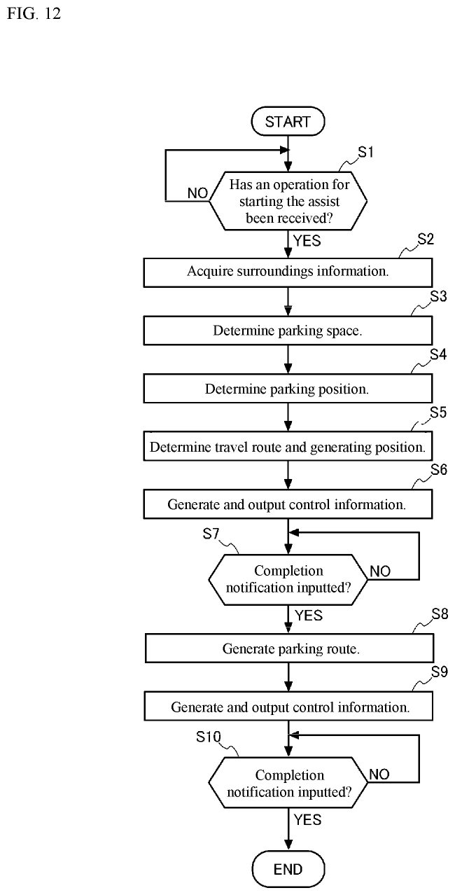

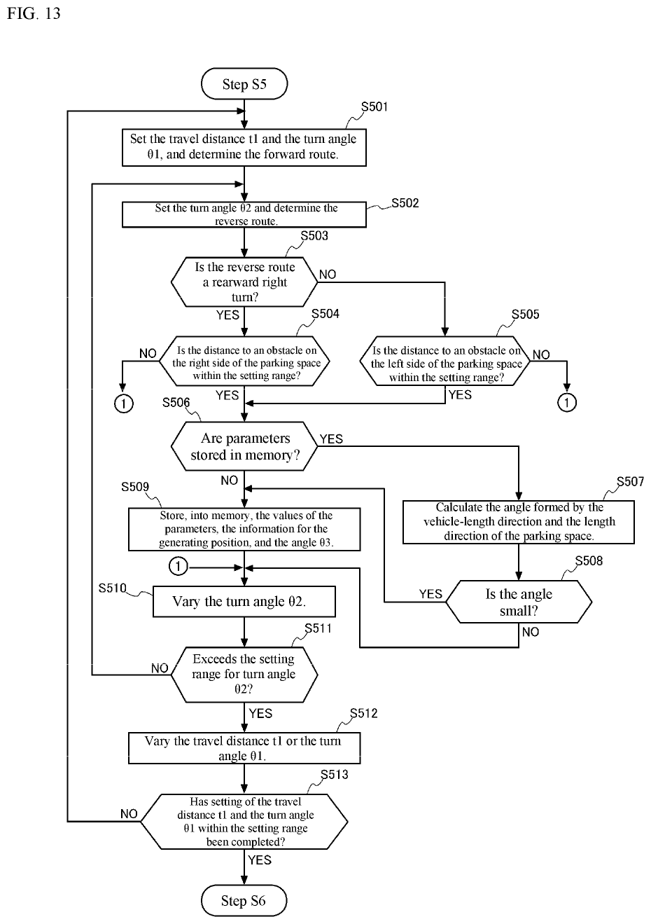

FIG. 12 and FIG. 13 are flowcharts showing the operation of the parking assist system 100. The operation of the parking assist system 100 will be explained in reference to FIG. 12 and FIG. 13.

First the parking assist system 100 evaluates whether or not an operation to start the parking assist has been received through a touch operation on the display unit 50 (Step S1). If no operation for starting the parking assist has been received (Step S1/NO), the parking assist system 100 delays the commencement of the next process until receiving the operation for starting.

When an operation for starting the parking assist is received through a touch operation on the display unit 50 (Step S1/YES), the parking assist system 100 acquires, from the detecting system 20, surroundings information that is information for the surroundings of the vehicle 1A (Step S2). Based on the surroundings information that is acquired, the parking assist system 100 determines a parking space W for parking the vehicle 1A (Step S3). Step S3 corresponds to the “determining step.”

The parking assist system 100 sets the angle and position for when the vehicle 1A is to be parked in the parking space W, to determine the parking position P for parking the vehicle 1A (Step S4). The parking assist system 100 then determines the travel route R1 and the generating position S3 (Step S5), and outputs, to the vehicle controlling unit 70, control information corresponding to the travel route R1 that has been determined (Step S6). Step S5 corresponds to the “route generating step.” Step S6 corresponds to the “outputting step.”

The parking assist system 100 next evaluates whether or not a completion notification, which is a notification that travel to the generating position S3 has been completed, has been inputted from the vehicle controlling unit 70 (Step S7). If the completion notification has not been inputted (Step S7/NO), the parking assist system 100 waits until the completion notification has been inputted.

When the completion notification has been inputted (Step S7/YES), the parking assist system 100 generates a surroundings map based on the surroundings information newly acquired at the generating position S3, and generates the parking route R2 based on the surroundings map that is generated (Step S8).

When the parking route R2 has been generated, the parking assist system 100 generates control information corresponding to the generated parking route R2, and outputs the generated control information to the vehicle controlling unit 70 (Step S9).

The parking assist system 100 next evaluates whether or not a completion notification, which is a notification that travel to the parking position P has been completed, has been inputted from the vehicle controlling unit 70 (Step S10). If the completion notification has not been inputted (Step S10/NO), the parking assist system 100 waits until the completion notification has been inputted. When the parking assist system 100 inputs the completion notification (Step S10/YES), this process flow is completed.

FIG. 13 is a flowchart showing the details for Step S5.

Detailed operations for Step S5 will be explained in reference to FIG. 13. First the parking assist system 100 sets the travel distance t1 and turn angle θ1, to set the forward turning route R1A (Step S501). The parking assist system 100 then sets the turn angle θ2 to set the backward turning route R1B (Step S502).

The parking assist system 100 next evaluates, based on the turn angle θ2 that has been set, whether the backward turning route R1B is a rearward right turn (Step S503).

If the backward turning route R1B is a rearward right turn (Step S503/YES), the parking assist system 100 evaluates whether or not the distance between the vehicle 1A and an obstacle that is present on the right side of the parking space W will be within the setting range if the vehicle 1A were to travel along the forward turning route R1A and the backward turning route R1B (Step S504).

If the evaluation is that the distance to the obstacle will not be within the setting range if the vehicle 1A were to travel (Step S504/NO), the parking assist system 100 moves to the process in Step S510 and changes the value of the turn angle θ2 (Step S510). If the evaluation is that the distance to the optical will be within the setting range if the vehicle 1A were to travel (Step S504/YES), the parking assist system 100 moves to the evaluation in Step S506.

Additionally, if the backward turning route R1B is not a rearward right turn, but rather a rearward left turn (Step S503/NO), the parking assist system 100 evaluates whether or not the distance between the vehicle 1A and an obstacle that is present on the left side of the parking space W will be within the setting range if the vehicle 1A were to travel along the forward turning route R1A and the backward turning route R1B (Step S505).

If the evaluation is that the distance to the obstacle will not be within the setting range if the vehicle 1A were to travel (Step S505/NO), the parking assist system 100 moves to the process in Step S510 and changes the value of the turn angle θ2 (Step S510). If the evaluation is that the distance to the obstacle will be within the setting range if the vehicle 1A were to travel (Step S505/YES), the parking assist system 100 moves to the evaluation in Step S506.

In Step S506, the parking assist system 100 evaluates whether or not values for parameters have been stored in the memory 120. If values for the parameters have been stored in the memory 120 (Step S506/YES), the parking assist system 100 calculates the angle θ3 that would be formed between the vehicle-length direction m2 of the vehicle 1A at the generating position S3 and the lengthwise direction W1 of the parking space W (Step S507).

The parking assist system 100 compares the calculated angle θ3 and the angle θ3 that would be formed between the vehicle-length direction m2 of the vehicle 1A and the lengthwise direction W1 of the parking space W at the position that is stored as a candidate for the generating position S3 in the memory 120. If the angle θ3 that has been calculated is no less than the angle θ3 that would be formed at the position that was stored as a candidate for the generating position S3 in the memory 120 (Step S508/NO), the parking assist system 100 moves to the process in Step S510, and the value of the turn angle θ2 is varied.

Moreover, if the calculated angle θ3 is less than the angle θ3 that will be formed at the position that is stored in the memory 120 as a generating position S3 candidate (Step S508/YES), the parking assist system 100 stores the information for the generating position S3 and the information for the angle θ3 in the memory 120 (Step S509). Moreover, even no values for the conditions have been stored in the memory 120 (Step S506/NO), the parking assist system 100 stores, into the memory 120, the values of the parameters, the information for the generating position S3, and the information for the angle θ3 (Step S509). The information for the generating position S3, stored in the memory 120, may be information for the position at the end of the backward turning route R1B, or may be information for a position that has returned, in that the direction of the intermediate position S2, by a prescribed distance from the end of the backward turning route R1B.

The parking assist system 100 next varies the value of the turn angle θ2 (Step S510), and evaluates whether or not the varied turn angle θ2 exceeds the range that is settable as the turn angle θ2 (Step S511). If the turn angle θ2 does not exceed the range that is settable as the turn angle θ2 (Step S511/NO), the parking assist system 100 returns to Step S502, and changes the value of the turn angle θ2 and sets the backward turning route R1B based on the varied turn angle θ2 (Step S502). Moreover, if the turn angle θ2 exceeds the range that is settable as the turn angle θ2 (Step S511/YES), the parking assist system 100 varies the value of the travel distance t1 or of the turn angle θ1 (Step S512).

The parking assist system 100 next evaluates whether or not all of the setting of the travel distance t1 and turn angle θ1 has been completed within settable ranges (Step S513). That is, the parking assist system 100 evaluates that setting of the travel distance t1 and the turn angle θ1 has all been completed in the setting range if either the travel distance t1 or the turn angle θ1 for which the value has been varied in Step S512 is a value that is greater than the settable range and would be a value that is greater than the settable range even if the other value, of the turn angle θ1 and travel distance t1 were changed. If the parking assist system 100 evaluates that setting of the travel distance t1 and turn angle θ1 into the settable range has not all been completed (Step S513/NO), processing returns to Step S501, and the parking assist system 100 varies the value of either the travel distance t1 or the turn angle θ1. Moreover, if the parking assist system 100 evaluates that the setting of the travel distance t1 and turn angle θ1 into the settable range has all been completed (Step S513/YES), processing moves to Step S6.

As explained above, the parking assist system 100 according to the present embodiment comprises an input/output I/F 110, a parking position determining unit 134, a route generating unit 135, and a control information generating unit 136.

The input/output I/F 110 is connected to onboard sensors that are installed at a plurality of positions, including the back end of the vehicle 1A.

Upon inputting, from the onboard sensors through the input/output I/F 110, surroundings information indicating the state of the surroundings of the vehicle 1A, the parking position determining unit 134 determines, based on the inputted surroundings information, a parking space W wherein the vehicle 1A is to park.

The route generating unit 135 generates a generating position S3 for generating the parking route R2 for parking the vehicle 1A in the parking space W that has been determined, and generates a travel route R1 by which the vehicle 1A will travel to the generating position S3.

The control information generating unit 136 generates control information by which the vehicle 1A will travel along the travel route R1, that is, control information for controlling the driving system 80 for causing the vehicle 1A to travel, and outputs the control information, through the input/output I/F 110, to the vehicle controlling unit 70 for controlling driving of the driving system 80.

The route generating unit 135 determines a generating position S3 so that at least a portion of the back end of the vehicle 1A will be positioned within the parking space, and, at the generating position S3 after the vehicle 1A has arrived at the generating position, generates the parking route R2 for parking the vehicle 1A in the parking space W.

The onboard sensors have higher accuracy of sensor data when they are close to that which is being sensed, so highly accurate sensor data is produced through determining the generating position S3 so that at least a portion of the back end of the vehicle 1A will be positioned in the parking space W, enabling the vehicle 1A to park with good accuracy within the parking space W.

Moreover, because the vehicle 1A does not adjust the route while traveling, this can shorten the time required for completion of parking.

The backward turning route R1B generated by the route generating unit 135 includes a turning route.

When the route generating unit 135 generates a route wherein the vehicle 1A turns to the right rearward, as the backward turning route R1B, the route generating unit 135 determines a generating position S3 such that the distance to an obstacle that is located on the right side of the vehicle 1A when the vehicle 1A has reversed into, and parked in, a parking space, will be a distance within a range that has been set in advance, and generates a travel route R1 by which the vehicle 1A will travel to the generating position S3 that has been determined.

Moreover, when the route generating unit 135 generates a route wherein the vehicle 1A turns to the left rearward, as the backward turning route R1B, the route generating unit 135 determines a generating position S3 such that the distance to an obstacle that is located on the left side of the vehicle 1A when the vehicle 1A has reversed into, and parked in, a parking space, will be a distance within a range that has been set in advance, and generates a travel route R1 by which the vehicle 1A will travel to the generating position S3 that has been determined.

This enables easy determination of a generating position S3 that is a position wherein at least a portion of the back end of the vehicle 1A will be within a parking space W, and easy generation of a travel route R1 for the vehicle 1A to travel to the generating position S3 that has been determined.

The route generating unit 135 calculates the angle that would be formed between the vehicle-length direction of the vehicle 1A and the lengthwise direction of the parking space if the vehicle 1A were positioned at the generating position, and varies the backward turning route R1B so as to reduce the calculated angle.

This makes it possible for the back end of the vehicle 1A to face in the direction of the parking space W, and possible to further improve the accuracy of the sensor data that is outputted by the onboard sensors that are mounted on the back end of the vehicle 1A.

The embodiment set forth above is no more than an illustrative example of one form of the present invention, where the present invention may be modified and applied as appropriate in a scope that does not deviate from the spirit and intent of the present invention.

For example, while the block diagram showing a structure for the parking assist system 100 shown in FIG. 1 is a schematic diagram wherein the structural elements are partitioned depending on the main processing details, to facilitate understanding, the structural elements may be partitioned into more structural elements depending on the details of the processes. Moreover, the partitioning may be such that more processes are carried out by a single structural element.

Moreover, in FIG. 1 the parking assist system 100 may be structured integrally with the position detecting unit 10 and/or a detecting system 20.

Moreover, when the parking assist method according to the present invention is achieved using a computer, it may be structured in the form of a medium for recording a program that is to be executed on the computer or a transmission medium for transmitting the program. The recording medium may use a magnetic or optical recording medium, or a semiconductor memory device. Specifically, it may be a fixed recording medium or a portable recording medium such as a flexible disk, an HDD (Hard Disk Drive) a CD-ROM (Compact Disk Read-Only Memory), a DVD, a Blu-ray® Disc, a magnetooptical disc, a flash memory, a card-type recording medium, or the like. Moreover, the recording medium may instead be a non-volatile storage device, such as a ROM, an HDD, or the like, provided with the parking assist system 100.

Moreover, the processing unit in the flowcharts shown in FIG. 7 and FIG. 8 are partitioned depending on the main processing units to facilitate easy understanding of the processes of the parking assist system 100, but the present invention is not limited by the names and ways in which the processing units are divided. The processes of the parking assist system 100 may be divided into more processing units depending on the process details. Moreover, the processes of the parking assist system 100 may instead be divided so as to include more processes in a single processing unit.

### EXPLANATIONS OF REFERENCE SYMBOLS

1A: Vehicle
1B: Another Vehicle
3: Onboard System
5: Communication Bus
7: Structure
10: Position Detecting Unit
20: Detecting System
30: Imaging Unit
31: Front Camera
32: Rear Camera
33: Left Side Camera
34: Right Side Camera
40: Sonar Unit
53: Touch Sensor
70: Vehicle Controlling Unit
80: Driving System
81: Steering System
83: Power System
85: Braking System
87: Transmission System
100: Parking Assist System
110: Input/Output I/F
120: Memory
130: Processor
131: Position Acquiring Unit
132: State Acquiring Unit
133: Surroundings Map Generating Unit
134: Parking Position Determining Unit
135: Route Generating Unit
136: Control Information Generating Unit
P: Parking Position
R1: Travel Route
R1A, R2A: Forward Turning Routes
R1B, R2B: Backward Turning Routes
R2: Second Parking Route
S1: Starting Position
S2: Intermediate Position
S3: Generating Position
S3: Step
S4: Intermediate Position

What is claimed is:

1. A parking assist system, comprising:
an input/output interface configured to connect to onboard sensors that are mounted at a plurality of positions, including a back end of a vehicle;
a parking position determining unit configured to determine a parking space for parking the vehicle based on inputted surroundings information when surroundings information, indicating the state of the surroundings of the vehicle, is inputted from the onboard sensors through the input/output interface;
a route generating unit configured to determine a generating position, which is a position for generating a parking route for the vehicle to park in the parking space that has been determined, and for generating a travel route for the vehicle to travel to the generating position; and
a control information generating unit configured to generate control information for controlling a driving system for traveling the vehicle along the travel route, and output the control information through the input/output interface to a controlling device for controlling driving of the driving system, wherein:
the route generating unit determines the generating position so as to position a portion of the back end of the vehicle within the parking space; and
generates a parking route from the generating position to the parking space when the vehicle has arrived at the generating position.

2. A parking assist system according to claim 1, wherein:
in the route generating unit, a backward turning route is included in the travel route that is generated; and
the route generating unit:
if generating a rearward right travel path as the backward turning path, determines the generating position so that the distance to an obstacle that is positioned on the right side of the vehicle, when the vehicle has backed into and parked in the parking space, will be a distance that is within a range that is set in advance, and generates the travel path for the vehicle to generate to the generating position that has been determined; and
if generating a rearward left travel path as the backward turning path, determines the generating position so that the distance to an obstacle that is positioned on the left side of the vehicle, when the vehicle has backed into and parked in the parking space, will be a distance that is within a range that is set in advance, and generates the travel path for the vehicle to generate to the generating position that has been determined.

3. A parking assist system according claim 2, wherein:
when the vehicle is positioned in the generating position, the path generating portion calculates an angle that will be formed between the vehicle-length direction of the vehicle and the lengthwise direction of the parking space, and varies the backward turning path so as to reduce the calculated angle.

4. A parking assist method comprising:
a determining step, for determining a parking space for parking the vehicle, based on the inputted surroundings information when inputting, from onboard sensors that are mounted at a plurality of positions, including the back and of a vehicle, of surroundings information that indicates the state of the surroundings of the vehicle;
a route generating step for determining a generating position, which is a position for generating a parking route for the vehicle to park in the parking space that has been determined, and for generating a travel route for the vehicle to travel to the generating position; and
an outputting step for generating control information for controlling a driving system for causing the vehicle to travel along the travel route, and for outputting the generated control information to a controlling device for controlling driving of the driving system, wherein:
the routes generating step determining the generating position so as to position at least a portion of the back end of the vehicle within the parking space and
after the vehicle has arrived at the generating position, generates, at the generating position, a parking route for the vehicle to park in the parking space.
